(19) United States
(12) Patent Application Publication
(10) Pub. No.: US 2026/0127536 A1
(43) Pub. Date: May 7, 2026

(54) ARTIFICIAL INTELLIGENCE INTEGRATION SCORING SYSTEM AND METHOD

(71) Applicants: Rodney Patrick Mock, Santa Margarita, CA (US); Martin Mehl, Orcutt, CA (US)

(72) Inventors: Rodney Patrick Mock, Santa Margarita, CA (US); Martin Mehl, Orcutt, CA (US)

(21) Appl. No.: 18/935,432

(22) Filed: Nov. 2, 2024

Related U.S. Application Data
(60) Provisional application No. 63/596,256, filed on Nov. 4, 2023.

(51) Int. Cl. G06Q 10/0639

(52) U.S. Cl. CPC G06Q 10/06393

(57) ABSTRACT

Disclosed herein are systems and methods for generating an Al work score for tasks assisted by artificial intelligence. The score is determined by collecting and processing user data using scoring algorithms that consider at least one of the following: Al integration, task complexity, baseline metrics, and time calibration. The system and methods also generate composite scores across users, tasks, groups or industries and classifications across various metrics, enabling correlation reports. These scores can assist in evaluating Al integration, optimizing task assignments and improving Al usage in supervised environments.

### CROSS-REFERENCE TO RELATED APPLICATIONS

This application claims priority from U.S. provisional application number 63/596,256 filed on Nov. 4, 2023, the entirety of which is hereby fully incorporated by reference herein.

### FIELD

This disclosure relates to methods and systems for evaluating artificial intelligence integration into the performance of tasks. Specifically, the present disclosure relates to collecting applicable data, computing and communicating certain performance scores involving the integration of artificial intelligence into assigned tasks.

### BACKGROUND

The science and engineering of making machines intelligent has resulted in several definitions of “artificial intelligence” and various subfields such as deep learning and machine learning. At its core, artificial intelligence involves combining computer science with extremely large data sets to solve problems thereby simulating human intelligence. Artificial intelligence has been classified into four types, reactive machines, limited memory, theory of mind and self-awareness. For this disclosure, and its discussion of artificial intelligence, any references herein to “AI” or “artificial intelligence” refers to all types of artificial intelligence. AI is being incorporated into everything from automation to machine learning, machine vision, natural language processing, self-driving cars, text image, audio, and computer code generation. AI is also making its way into aerospace, aviation, agriculture, automotive and transportation, banking, business construction and architecture, criminal justice, customer service, education, energy and utilities, environmental, government and defense, monitoring healthcare, human resources, IT processes, law, manufacturing, media, music, non-profits, pharmaceutical and drug discovery, real estate, retail and e-commerce, social security, media and advertising, software development and supply chain management.

Regardless of the discipline or industry involved, however, when AI is incorporated into such, some sort of “supervisor” and “supervisee” relationship will generally be present. For example, in the employment context, the employer is the supervisor, and the employee is the supervisee. In academia, it is the educator that fills the role of supervisor, and the student of the supervisee. In these relationships, the quality of AI integration often affects the supervisor's evaluation of the supervisee's performance, but traditional metrics overlook this critical interaction. Thus far, the primary focus on assessing the performance of AI has been largely centered on the input and output of the various AI models and determining confidence scores. AI models are evaluated based on certain metrics such as, among other things, precision, recall, AUC/ROC Curve and F-Score. These metrics focus on the AI's output quality in isolation rather than its impact when integrated into supervised tasks where human-AI collaboration is critical. Metrics such as precision and recall may indicate the accuracy of AI outputs, but they do not capture the unique aspect of the extent to which the AI's recommendations are successfully integrated into final work product. In other words, when a supervisor assigns an AI assisted task to a supervisee what exactly is the AI user doing with the AI output to “integrate” such into the final work product and how is the assessment of that measured. This disclosure technologically addresses such by, among other things, collecting and computing certain online data associated with the supervisor and the AI user to determine and communicate, among other things, an AI work score. Unlike traditional metrics, the AI work score measures the effectiveness of AI integration by considering, among other things, user interaction, context-specific adjustments and communicated feedback in a supervised environment. This AI work score also is designed to be versatile, allowing for certain adjustments by the supervisor to the scoring system to account for the type of AI assisted task and the nature of the supervised environment. While some existing approaches attempt to include user feedback in AI evaluation, they fail to account for the variability in task complexity, supervisor input, individual user proficiency and how the Al's suggestions ultimately influence final work product quality.

There is a significant business and educational need for an AI work score method and system to properly assess AI assisted tasks when AI users are integrating AI into their final work product. The lack of an AI work score in education and business results in inefficient recourse allocation, suboptimal training outcomes and challenges in proper performance evaluations. To address these gaps, the present invention introduces a unique method and system for determining an AI work score that comprehensively assesses AI assisted tasks. For all relevant purposes herein “AI work score” and “AI work scores” shall be synonymous.

### SUMMARY

Set forth herein this disclosure are methods and systems for generating an AI work score when a task is performed with AI assistance. This AI work score is designed to provide a performance assessment of an AI user's integration of AI into the final work product of an assigned task. This score will assist, AI users, employers, educators, accreditors, companies training AI models, and stakeholders, in assessing AI integration into final work product.

In certain embodiments a method for computing an AI work score involves collecting online data of the AI user and supervisor which, includes AI user data, supervisor data, an AI assigned task, an AI user disclosure, final work product and other online data. In a further embodiment, such collected data may then be used to determine an AI work score based on scoring algorithms that consider one or more of the following: AI integration, task complexity, baseline metrics, and time calibration. Additionally, in a further embodiment, the supervisor may also customize the AI work score by selecting and adjusting one or more of the weights assigned to AI integration, task complexity, baseline metrics, and time calibration.

In a further embodiment of the invention the collected data, may also be used to generate composite AI work scores by users, composite scores by tasks, various sub-scores by users, various sub-scores by tasks, by groupings, by rankings, by subject matter, across time, across industries, across KPI standards, and other sub-scoring categorizations and/or classifications, which may be configured and analyzed for specific implementations, and used to generate various correlation reports.

In a further embodiment of the method, the AI work score, the composite scores, the sub-scores and/or the classifications may be communicated via dynamically generated data visualizations, graphs, charts, illustrations and/or customizable dashboards tailored to user preferences and task requirements. Additionally, in a further embodiment, such communications may also include various notifications, alerts and messages when the AI work score, composite scores or sub-scores exceed or fall below certain predefined thresholds.

In a further embodiment of the invention is a system for determining an AI work score which may include a data capture module that collects, AI user data, supervisor data, an AI disclosure, the AI assigned task, the final work product, supervisor input and other online data. Additionally, in a further embodiment, the system also may include a scoring module that processes the collected data and determines an AI work score based on certain scoring algorithms. In another embodiment involving the scoring module, the system is further configured to allow the supervisor to customize the AI work score by selecting and adjusting one or more of the weights assigned to AI integration, task complexity, baseline metrics, and time calibration.

In a further embodiment, the system may also include a data analytics module where the collected system data may be used to generate other scoring analysis such as composite AI work scores by users, composite scores by tasks, various sub-scores by users, various sub-scores by tasks, by groupings, by rankings, by subject matter, across time, across industries, across KPI standards, and other sub-scoring categorizations and/or classifications, which may be configured for specific implementations, and used to generate various correlation reports.

In another embodiment of the invention, the system may also include a score delivery module that displays, visualizes, charts, illustrates and communicates an AI work score to the AI user, the supervisor, and stakeholders. In a further embodiment, the score delivery module may also include the display, visualization, and transmission of sub-scores and various correlation reports to the AI user, supervisor, and stakeholders, which may be configured for specific implementations. The score delivery module may also include customizable dashboards tailored to user preferences and task requirements.

Finally, in another embodiment of the system, the score delivery module, may also include various notifications, alerts and messages when the AI work score, composite scores or sub-scores exceed or fall below certain predefined thresholds.

### BRIEF DESCRIPTION OF DRAWINGS

The embodiments of the invention discussed above, the various features, operation, as well as adaptations, in this disclosure will be more apparent from the following detailed description as presented in conjunction with the following several figures of the drawings. These embodiments as illustrated in the figures of the drawings are by way of example only, and not intended to be construed as a limitation of the embodiments of the invention.

FIG. 1 is a system diagram by way of illustration setting forth an AI work scoring system which includes various computer modules for scoring.

FIG. 2 is a block diagram by way of illustration showing the scoring module in greater detail for computing an AI work score.

FIG. 3 is a conceptual illustration of a computer in the form of a mobile device displaying the supervisor's customization interface of the scoring algorithm.

FIG. 4 is a conceptual illustration of a computer in the form of a mobile device displaying a dynamic communication of an AI user's AI work score and other scoring analysis.

FIG. 5 is a conceptual illustration of a computer in the form of a mobile device displaying a correlation report of an AI user's cumulative AI work scores.

FIG. 6 illustrates an example method for determining an AI work score.

FIG. 7 illustrates an example computer system.

The elements set forth in the above figures are for illustrative purposes only, for clarity and simplicity, and are not illustrated in accordance with scale, as certain elements for example may be emphasized and others deemphasized relative to others that are necessary, common, or useful in a commercially feasible embodiment, as this is done to provide a less obstructive view of the embodiments disclosed for better comprehension.

### DETAILED DESCRIPTION

The description set forth below discusses certain details and concepts involving the various embodiments of the invention. The following description and the presented concepts should not be construed as limiting these embodiments, but rather, are discussed for the purposes of presenting the general concepts of the embodiments of the invention. The concepts discussed herein may be described in conjunction with one or more specific embodiments. This does not mean, however, that such concepts, are limited to such embodiments, or that such embodiments are limited to such concepts.

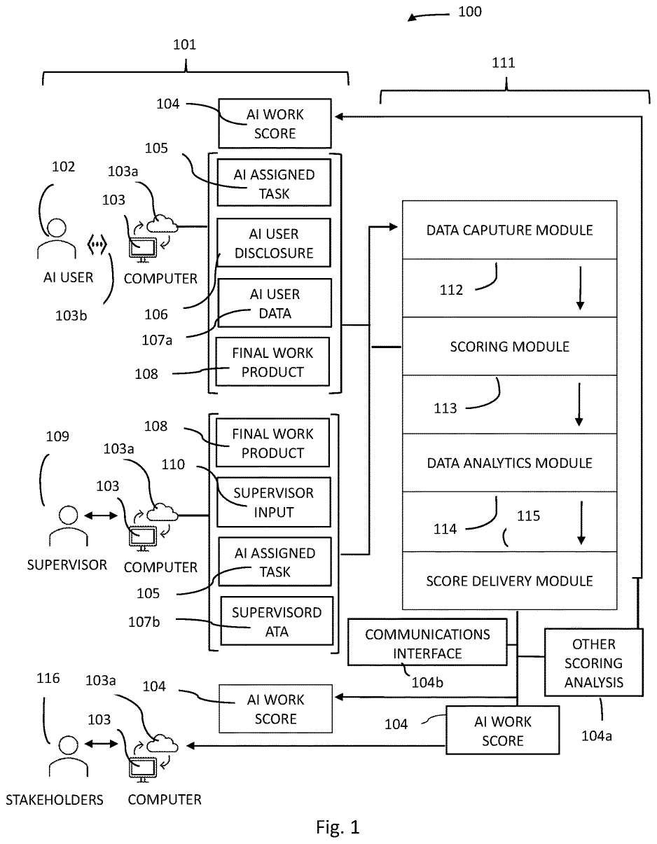

Referring to FIG. 1 a system diagram of an overall scoring system for determining an Al work score 104 is shown in accordance with an embodiment of the invention. An Al work score 104 may include a performance measurement of an AI user's 102 integration of AI 103b into the final work product 108 of an AI assigned task 105 by a supervisor 109. The AI user's 102 other scoring analysis 104a may include, but is not limited to, composite AI work scores by users, composite scores by tasks, various sub-scores by users, various sub-scores by tasks, by rankings, by groupings, by subject matter, across time, across industries, across KPI standards, and other sub-scoring categorizations and/or classifications, which may be configured for specific implementations, and used to generate correlation reports.

FIG. 1 illustrates an overall architecture 100 for a system 111 of determining an AI work score 104, which may include, a network 103a where both an AI user 102 and a supervisor 109 communicate information to each other 101 and to the system 111 via their respective computers 103. Within this architecture 100, the supervisor 109 inputs certain data into a computer 103 involving an AI assigned task 105 which is communicated to the AI user 102 by computer 103. The AI user 102 completes the AI assigned task 105 with the assistance of AI 103b using the computer 103. During this process AI user data 107a is also collected on the AI user 102. The AI user 102 inputs the final work product 108 into the computer 103 which is communicated to the supervisor 109. The AI user 102 also inputs AI user disclosure 106 information into the computer 103. The supervisor 109 provides supervisor input 110 on the final work product 108 into the computer 103. Supervisor data 107b is also collected during this process. The supervisor input 110 may include, but is not limited to, the supervisor setting an overall numerical baseline score of the final work product wherein the supervisor may consider, among other things, in determining such score, among other things, an assessment of accuracy and precision, quality, relevance, originality or creativity, adherence to task instructions, engagement with AI recommendations, consistency, feedback incorporation, overall utility and compliance with various ethical or legal standards. These considerations may vary by industry, task and supervisor expectations.

Depending on the adaptation involved of the embodiments of the invention, the supervisor 109 may also receive other relevant information, such as, but not limited to, AI user data 107a, and network 103a access to working drafts of the final work product 108.

The network 103a may include the internet or any other network capable of communicating data between the computers 103. This network 103a may include a private network such as a wireless data communication network, wide area network, a type of local area network, a combination of networks, or a public network such as the internet.

The AI user 102 may be comprised of one person or a group of persons working on one or more AI assigned tasks 105 from the supervisor 109. An AI user 102 may be, but is not limited to, a mentee, employee, apprentice, trainee, pupil, student, family member such as a child, or any other type of learner or learners working under the instruction of the supervisor 109. The supervisor 109 may be, but is not limited to, a mentor, employer, trainer, advisor, instructor, tutor, counsellor, coach, manager, family member such as a parent, or any other type of person or persons completing tasks under such person's supervision. The supervisor 109 may also be AI 103b in some circumstances. The supervisor 109 may or may not have subject matter expertise over the AI assigned task 105. Stakeholders 116 may be any other interested parties authorized to access the AI work score 104 and other scoring analysis 104a. Stakeholders 116 may include, one or more persons, such as, but not limited to, other employees of the organization of the AI user 102 and/or supervisor 109, human resources, accreditation bodies, academic institutions, researchers, third-party publishing companies, employment agencies, auditors, certain governmental organizations, and potential employers.

AI 103b refers to all types of artificial intelligence, including, but not limited to, reactive machines, limited memory, theory of mind and self-awareness. AI 103b may be directly accessible from the computer 103 without a network 103a or it may only be accessible through a network 103a or both. The computer 103 may include any device capable of connecting to a network 103a including, but not limited to, a computer, smart television, a mobile device or personal digital assistant, a tablet, wristwatches, game consoles, e-book readers, digital cameras, smart glasses, a vehicle, appliance, a robot, a smart speaker and any other such devices.

FIG. 1 also sets forth a block diagram of the various modules of the system 111 for determining an AI work score 104 illustrating further embodiments of the invention. While this system 111 may be depicted in the embodiment of FIG. 1 as a process, the system 111 may be practiced as a hardware device and/or software algorithm. This system 111 for determining an AI work score 104 may be comprised of the following modules, a data capture module 112, a scoring module 113, a data analytics module 114 and a score delivery module 115.

In certain embodiments of the invention, the data capture module 112 may be configured to collect online data 101 between the user 102, the supervisor 109, the computers 103 and the system 111. This online data 101 may include all data related to the AI user 102 and the supervisor 109 including, but not limited to, AI user data 107a, supervisor data 107b, the final work product 108, the AI assigned task 105, supervisor input 110 and the AI user disclosure 106. The AI user data 107a may include, but is not limited to, characteristic data on the AI user 102 such as the user's identifying information, status, password, login information, keystroke data, certain information related to the AI assigned task 105 such as: the amount of time spent on AI 103b, the number of AI 103b prompts, the type of AI 103b inputs and outputs, AI 103b usage history, the AI 103b tools deployed, any and all AI 103b watermarking data associated with the final work product 108 and drafts of the final work product 108, correspondence with other AI users 102, correspondence with the supervisor 109 and any other relevant information. Supervisor data 107b may include, but is not limited to, characteristic data on the supervisor 109 such as identifying information, status, password, login information, keystroke data, data associated with various AI assigned tasks 105 interactions between the AI user 102 and the supervisor 109 and any other relevant information.

The AI user disclosure 106 may include certain information inputted by the AI user 102 upon completion of the final work product 108 such as, the AI user's 102 assessment of AI 103b integration into the final work product 108, disclosure on the exact composition of the final work product 108 (e.g., how much is comprised of drafting, computer code, images, research, mathematical formulas, analysis, etc.) and an estimate of how much was generated by AI 103b, links to any AI 103b queries associated with the AI assigned task 105 and final work product 108 and any other data relevant in determining an AI work score 104. The final work product 108 may include the final product associated with addressing the AI assigned task 105. This final work product 108 may be in the form of all data types, including, for example: portable document format (PDF), word document (DOC), hypertext markup language (HTML), comma-separated values (CSV), text file (TXT). java source, code (JAVA), python script (PY), java script (JS), cascading style sheets (CSS), hypertext markup language (HTML), Microsoft excel (XLSX), comma-separated values (CSV), Google sheets (GSHEET), open document spreadsheet (ODS), tab-delimited text (TAB), Microsoft power point (PPT), Apple keynote (KEY), Google slides (SLIDES), open document presentation (ODP), waveform audio file (WAV), free lossless audio code (FLAC), advanced audio coding (AAC), MPEG audio layer III (MP3), ogg vorbis (OGG), Matroskator graphics (SVG), encapsulated post script (EPS), Adobe Illustrator (AI), CorelDRAW (CDR), Windows metafile (WMF), joint photog collada digital asset (DAE), Windows icon (ICO), Apple icon image (ICNS), portable any map (PAM), X bitmap (XBM), Windows cursor (CUR), stereolithography (STL), wavefront 3D object (OBJ), 3D studio (3DS), virtual reality modeling language (VRML), collada digital asset (DAE) and any other types of data that may be electronically communicated. The above data types mentioned are for illustrating certain embodiments of the invention only and are not intended to be limiting or exhaustive in any way.

The AI assigned task 105 may include one or more assigned tasks, involving, academic assessments, academic assignments, aerospace reviews, articles and blog posts, artwork, asset valuations, athletic assessments, audit reports, auditing, banking transactions, behavioral reports, budget analysis, budget reports, case studies, schematics, code compliance, content analytics, copywriting and advertising content, crop analysis, customer feedback and reviews, data analysis, data analysis and visualizations, debugged code, design projects, development plans, diagnostic images, economic analysis, educational assignments, educational materials, educational projects, educational software, e-learning courses, energy audits, environmental impact reports, environmental impact assessments, experimental data, farm management reports, feedback session reports, financial plans, financial reports, financial statements, growth reports, health assessment audits, historical essays, inventory management reports, investment portfolios, lab reports, legal briefs, legal contracts and agreements, legal opinions, learning journals, lesson plans, literary analysis, market research, marketing campaigns, marketing performance reports, medical diagnosis, medical research papers, medical reports, nonprofit program evaluations, policy analysis, policy evaluations, prescriptions, product designs, quality control reports, research papers, risk assessments, sales performance, sales proposals, sales contracts, social media content, software applications, support agreements, team assessment, training feedback, training manuals, website and user interface designs, whitepapers and any other conceivable type of assigned task or tasks. The tasks mentioned above in this disclosure are for illustrative purposes only and are not intended to be limiting or exhaustive in any way of the AI assigned task 105 as such may vary by industry and the nature of the task. The AI assigned task 105 may also include various work parameters or targets inputted by the supervisor 109 such as, but not limited to, total time allocated to the task or tasks, total time allocated to AI 103b, a complexity assessment of the task by the supervisor 109, a baseline target, an integration target, an AI work score 104 target and any other relevant information. The AI assigned task 105 may also be modified, cancelled or reassigned from time to time by the supervisor 109. In addition, as part of the AI assigned task 105, the supervisor 109 may configure the AI work score scoring algorithm by selecting and adjusting one or more of the weights assigned to AI integration, task complexity, baseline metrics, and time calibration.

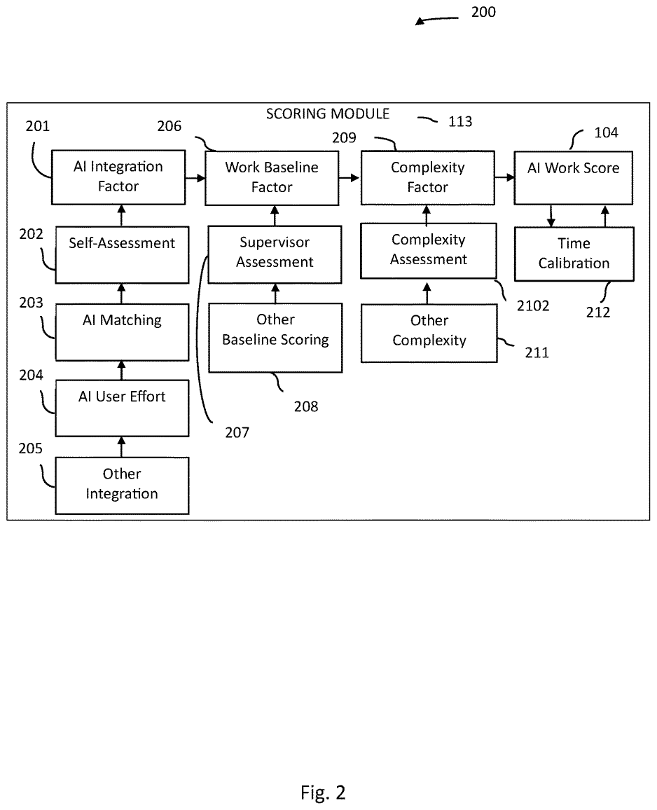

In certain embodiments of the invention, the scoring module 113 set forth in FIG. 1 may be configured to process the collected online data 101 from the data capture module 112 based scoring algorithms to determine a number, index, percentage, rating, or another indicant of an AI work score 104 for the AI task assigned 105. As shown in FIG. 2 the AI work score 104 may be computed in the scoring module 113 based on, one or more of the following: an AI integration factor 201, a work baseline factor 206, a complexity factor 209 and a time calibration 212. The factors may all have various attributable subfactors that impact the overall factor.

The AI integration factor 201 may be determined by certain subfactors, involving, self-assessment 202, AI matching 203, AI user effort 204 and other integration 205. The self-assessment 202 subfactor may include a numerical value assigned to the AI user's 102 self-assessment of AI 103b integration into the final work product 108 set forth in the AI user disclosure 106. The AI matching 203 subfactor may include a numerical value assigned to the amount of AI 103b output that can be “matched” to the final work product 108. AI matching 203 may be based on, among other things, digital watermarks, words, numbers, formulas, audio, video, computer code, pixels and any other information that may be digitally matched. AI matching 203 may also include any other manner of detecting AI content. The AI user effort 204 subfactor may include a numerical value assigned to the amount of time the AI user 102 spend on AI 103b completing the final work product 108, the amount of AI 103b time allocated to the AI assigned task 105 by the supervisor 109, the amount of non-AI time allocated to AI assigned task 105 by the supervisor 109, the number of AI 103b original prompts, the number of AI 103b revised prompts, AI 103b output matched to various drafts of the final work product 108 and any other relevant information. Other integration 205 may be an additional subfactor with a numerical value assigned based on any other information relevant to determining an AI integration factor 201.

The work baseline factor 206 may be determined by certain subfactors involving supervisor assessment 207 and other baseline scoring 208. The supervisor assessment 207 subfactor may include a numerical value assigned to the supervisor's 109 assessment of the final work product 108, which may involve, among other things, supervisor input 110. Other baseline scoring 208 may be an additional subfactor with a numerical value assigned based on any other information relevant to establishing baseline metrics, which may include, but is not limited to, information derived from artificial intelligence.

The complexity factor 209 may be determined by certain subfactors involving a complexity assessment 210 and other complexity 211. The complexity assessment 210 subfactor may include a numerical value assigned to the supervisor's 109 assessment of the overall complexity of the AI assigned task 105. Other complexity 211 information may be an additional subfactor with a numerical value assigned based on any other data relevant to complexity, which may include, but is not limited to, information derived from artificial intelligence.

The AI work score 104 is determined based on scoring algorithms wherein the online data 101 is assigned numerical values corresponding to at least one of: an AI integration factor 201, a work baseline factor 206, a complexity factor 209, or a time calibration 212. In certain cases, the AI work score 104 may be adjusted by such scoring algorithms in the event of a time calibration 212. A time calibration 212 occurs when the AI user 102 exceeds or does not exceed the AI 103b time allocated by the supervisor 109 as set forth in the AI assigned task 105. Additionally, in a further embodiment, the supervisor 109 when assigning an AI assigned task 105 may also customize the AI work score 104 by selecting and adjusting, one or more of the weights assigned to the AI integration factor 201, the work baseline factor 206, the complexity factor 209 and by making any necessary adjustments for a time calibration 212.

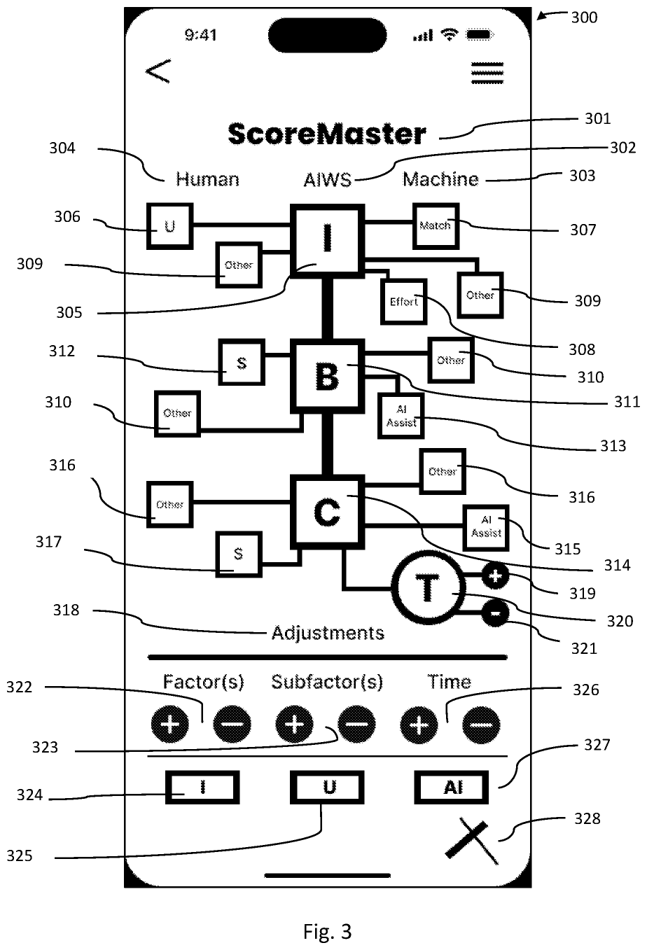

The illustration in FIG. 3 is an example display interface of a computer in the form of a mobile device 300. The mobile device interface 301 allows the supervisor 109 the ability to customize the scoring module's 113 factors, subfactors, and time calibration, for the purposes of determining the AI work score 302. On the right side of the mobile device interface 301 are the scoring module's 113 subfactors that are mechanical in nature 303 (e.g., time spent on task, AI output detection, etc.). The left side of the mobile device interface 301 are the scoring module's 113 subfactors that involve a degree of human assessment 304 (e.g., AI user disclosure 106). The center of the mobile device interface 301, sets forth the scoring module's 113 AI integration factor 305, the work baseline factor 311, the complexity factor 314 and the time calibration 320. On the left side of the AI integration factor 305 are the self-assessment 306 and other AI integration 309 subfactors. On the right side of the AI integration factor 305 are the AI matching 307, AI user effort 308 and other integration 309 subfactors. On the left side of the work baseline factor 311 are the supervisor assessment 312 and other baseline scoring subfactors 310. On the right side of the work baseline factor 311 are other baseline scoring 310 subfactors, which may include, AI assistance 313. On the left side of the complexity factor 314 are supervisor complexity assessment 317 and other complexity subfactors 316. On the right side of the complexity factor 314 are the other complexity subfactors 316, which may include, AI assistance 315.

At the bottom of the mobile device interface 301 is a supervisor control console 318 wherein the supervisor 109 may adjust the overall AI work score 104 by a time calibration 320 upward 319 or downward 321 depending on whether the AI user 102 exceeds the time expectations of the supervisor 109 or does not exceed time expectations 326. This time calibration adjustment 320 may be further refined by the supervisor 109 by total task time or total AI time 327. The supervisor control console 318 also allows the supervisor 109 to adjust the various weights assigned by the scoring algorithm of the factors 322 and subfactors 323, by selecting the applicable factor 324 or subfactor 325. At the right bottom of the mobile device interface 301 is a communications interface 104b navigational button 328.

In further embodiments of the invention, the data analytics module 114 may be configured to store, further process, and analyze AI work scores 104 generated from the scoring module 113 as well as online data 101 collected by the data capture module 112. The data analytics module 114 may generate certain other scoring analysis 104a such as composite AI work scores by users, composite scores by tasks, various sub-scores by users, various sub-scores by tasks, by groupings, by rankings, by subject matter, across time, across industries, across KPI standards, and other sub-scoring categorizations and/or classifications, which may be configured for specific implementations, and used to generate various correlation reports.

In further embodiments of the invention the score delivery module 115 may be configured to create various visualizations and/or displays and customizable dashboards of the AI work score 104 and other scoring analysis 104a collectively herein referred to as communications interface 104b. In addition, the communication interface 104b, may include various notifications, alerts and messages when the AI work score 104, composite scores or sub-scores exceed or fall below certain predefined thresholds. The communication interface 104b may be configured by the AI user 102, the supervisor 109 and stakeholders 116. The communications interface 104b may transmit such to the AI user 102, the supervisor 109 and stakeholders 116.

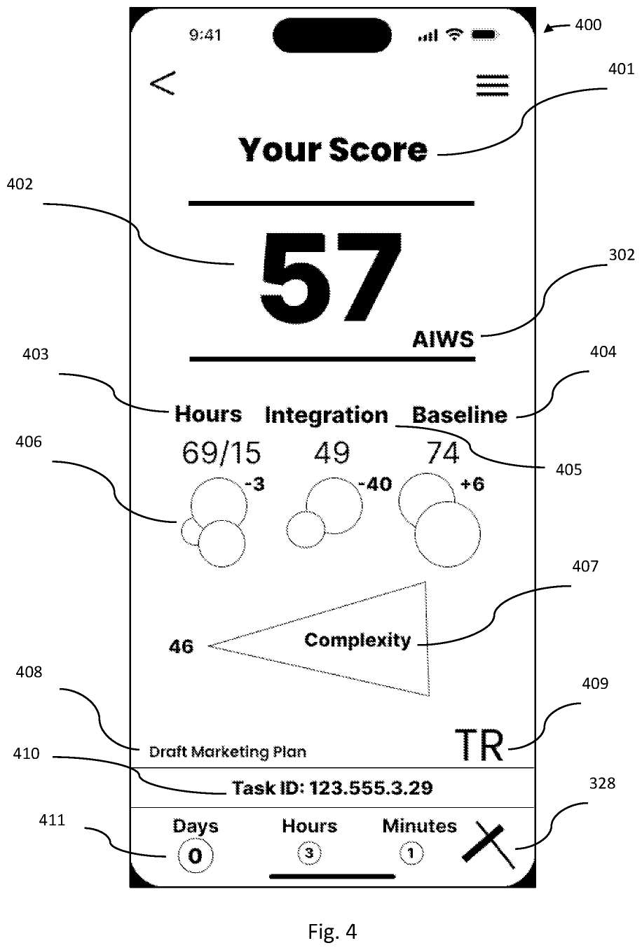

The illustration in FIG. 4 is a further display interface example of a computer in the form of a mobile device 400. This mobile device interface 400 is a dynamic visualization of the AI work score 401 and other scoring analysis 104a. The mobile device interface 400 provides the AI work score 402. The AI user 102, the supervisor 109 and stakeholders 116 may use the mobile device interface 400. In addition to the AI work score 401 the mobile interface 400 displays certain detailed information on the determination of the AI work score 402. This information on the mobile device interface 400 includes total AI user 102 hours spent on the AI assigned task 403 bifurcated between the AI time allocation and the total task time allocation 406. The mobile interface 400 also provides information on the integration factor score 405, the baseline factor score 404, and the complexity factor score 407. The mobile device interface 400 also contains a brief text description 408 of the AI assigned task 105 with a unique task identification number 410. At the bottom of mobile device interface 400 is a user display console 411 indicating any task time remaining and a communications interface 104b navigational button 328.

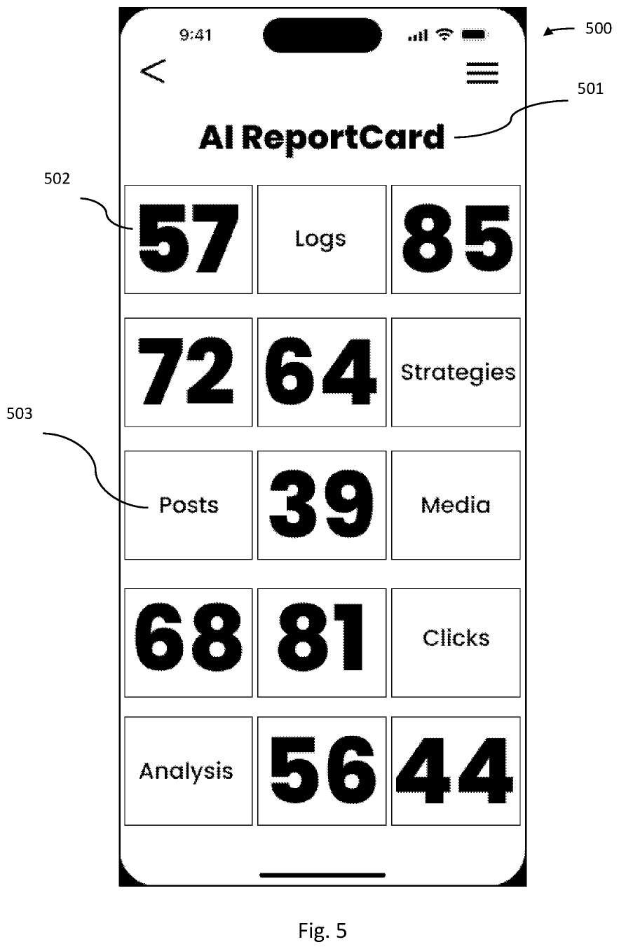

FIG. 5 is an additional display interface example of a computer in the form of a mobile device 500. The mobile device interface 500 is a conceptual illustration of other scoring analysis 104a involving an example correlation report. The example correlation report is an AI report card 501 providing an AI user's 102 current AI work scores 502 and historical AI work scores 104 (e.g., 85, 72, 64, 39, etc.). The AI user 102, the supervisor 109 and stakeholders 116 may use the mobile device interface 500. The mobile device interface 500 also has notifications, alerts, or brief messages on any outstanding AI assigned tasks 503 (e.g., logs, strategies, media clicks, etc.).

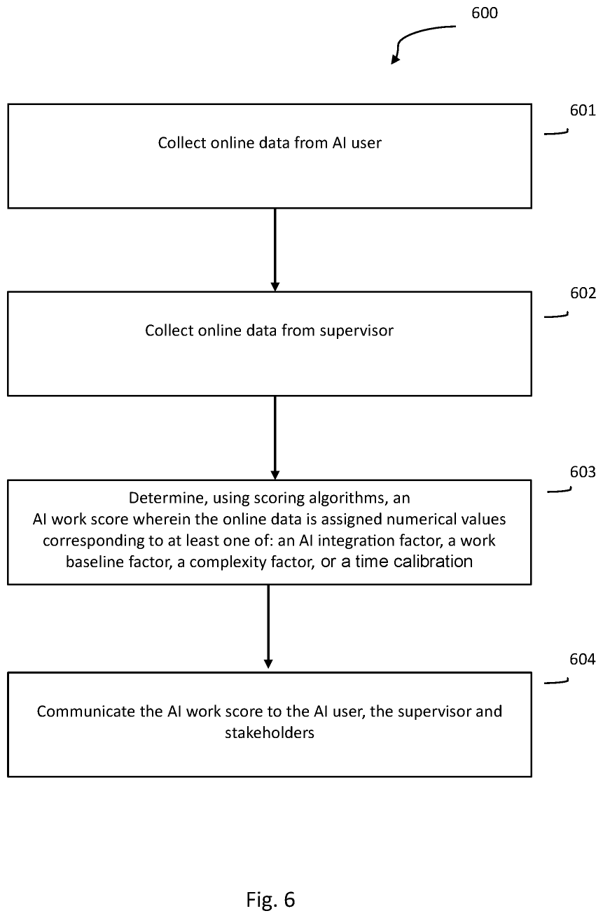

FIG. 6 shows a flow chart 600 for a method of determining an AI work score 104 in accordance with an example embodiment of the invention. This method may be practiced through processing logic that may comprise hardware (e.g., dedicated logic, microcode, programable logic, etc.) and/or software (e.g., computer code executed on a general-purpose computer system) which may be configured to perform one more functions. The method set forth in 600 may be performed by the various modules 111 described in FIG. 1 and processing logic.

As shown in 600 the method may commence at operation with the collection of online data from the AI user 601 by the data capture module 112. The initial online data collected from the AI user 601 may be, among other things, AI user data 107a from the AI user 102 logging onto the computer 103. The supervisor 109 may initiate an AI assigned task 105 by inputting in the computer 103 various task expectations for the AI user 102. The AI assigned task 105, supervisor input 110 and supervisor data 107b is collected online from the supervisor 602 by the data capture module 112. The AI user 102 receives the AI assigned task 105 and completes it with the assistance of AI 103b. The AI user 102 completes and submits an AI user disclosure 106. The AI user 102 also submits the final work product 108. The AI user disclosure 106, the final work product 108, the AI user data 107a is collected from the AI user 601 by the data capture module 112. The supervisor 109 receives the final work product 108 and provides supervisor input 110 assessing the final work product 108. The supervisor input 110 and supervisor data 107b is collected from the supervisor 602 by the data capture module 112.

Using scoring algorithms an AI work score is determined 603 by the scoring module 113 wherein the online data is assigned numerical values corresponding to at least one of: an AI integration factor, a work baseline factor, a complexity factor, or a time calibration Other scoring analysis 104a is generated by the data analytics module 114. The AI work score 104 and other scoring analysis 114 are communicated to the AI user, the supervisor and stakeholders 604 via the communications interface 104b by the score delivery module 115.

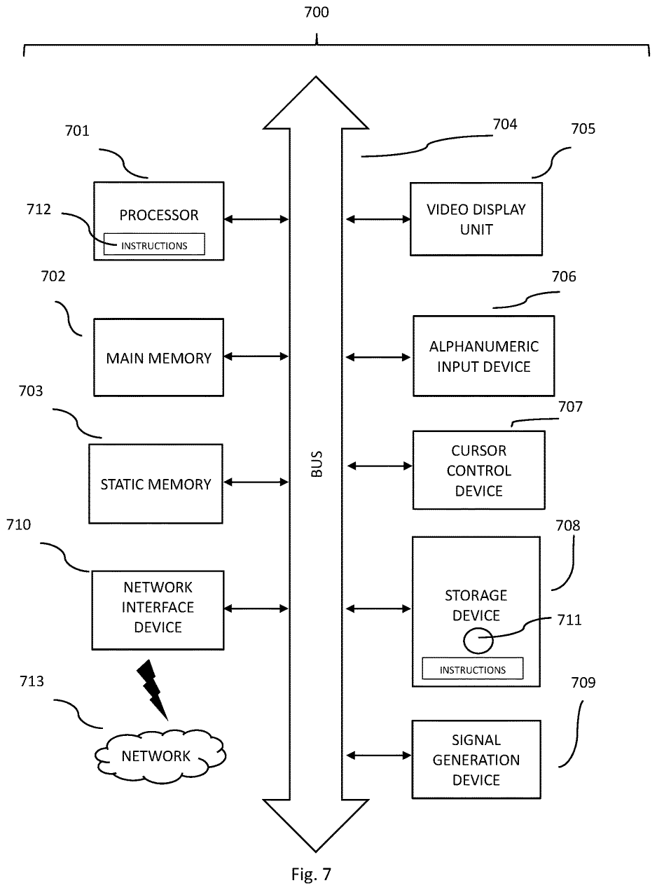

FIG. 7 illustrates an example computer system 700 wherein one or more of the methods or illustrations described herein are executed based on instructions such as those making up a computer program. This disclosure contemplates a computer system taking any suitable physical form. The computer system 700 may include, but is not limited to, a desktop computer system, a laptop, a notebook computer system, an interactive kiosk, a main-frame, a mesh computer system, a smart television, a mobile device, a wearable device, a handheld gaming console, an e-book reader, a tablet, a digital camera, an augmented reality device, a virtual reality device, a vehicle, a smart speaker, an appliance, a personal digital assistant, a robot and any combination thereof of the aforementioned.

While the illustration in FIG. 7 may refer to a single computer system 700 the illustration is not to be interpreted as limited to a single machine, as the instructions of the methods described herein may be performed by one or more machines that are jointly or individually executing the instructions, or multiple sets of the instructions, or parts of the instructions. The computer system 700 may be, but is not limited to, a unitary or distributed system, it may span multiple locations, it may also span across one or more data centers, may include a clustering system, a grid system or it may reside in the cloud on more or more networks. Depending on the embodiment of the invention executed by the computer system 700 the machine may operate in standalone manner, or it may be connected to a series of other machines through a network 713. The computer system 700 may also execute one or more the instructions of the various embodiments described herein at different times or different locations where appropriate.

The example computer system 700 in FIG. 7 includes a processor 701, which may include a single processor or multiple processors (e.g., a central processing unit (CPU), a graphics processing unit (GPU) or both), a main memory 702 and a static memory 703, which communicate with each other via a bus 704. The computer system 700 may further include a video display unit 705. The computer system 700 may also include an alphanumeric input device 706 (e.g., a keyboard), a cursor control device 707 (e.g., a mouse) and a storage device 708 (e.g., a disk drive unit), a signal generation device 709 (e.g., a speaker) and network interface device 710.

The storage device 708 includes a computer-readable medium 711 which stores one or more sets of instructions and data structures (e.g., instructions 712) embodying or utilized by any one or more of the methods or functions described herein. The instructions 712 may also be stored on in whole or in part within the main memory 702 and/or within the processor 701 during execution by thereof by the computer system 700. The main memory 702 and the processor 701 may also constitute computer-readable media.

The instructions 712 need not be stored locally, but rather may be transmitted or received over a network 713 using a network interface 710 using any one of the well-known transfer protocols, including, but not limited to, Hyper Text Transfer Protocol (HTTP).

For the purpose of this disclosure computer-readable medium 711 is not limited to a single medium, but rather, the term may include a single medium or multiple mediums, which may include, but is not limited to, recordable type media such as volatile and non-volatile memory devices; floppy and other removable disks; magnetic media; solid state memories; hard disk drives; optical disks; other similar non-transitory (or transitory), tangible (or non-tangible) storage medium; or any medium suitable for storage, encoding, or carrying instructions for execution by the computer system 700 to perform any one or more of the embodiments of the invention described in this disclosure, or that is suitable for storing, encoding or carrying data structures utilized or attributable to such instructions.

The embodiments described in the present disclosure are considered illustrative and not restrictive. In other words, various changes, modifications, adaptations, and solutions to various problems that may not be directly addressed herein this disclosure may be made to the embodiments without departing from the essential characteristics and spirit of the embodiments of the invention.

1. A method for calculating an AI work score, the method comprising:
collecting, by a processor, online data, associated with an AI user;
collecting, by the processor, online data, associated with a supervisor;
determining, by the processor, using scoring algorithms, an AI work score, wherein the online data is assigned numerical values corresponding to at least one of: an AI integration factor, a work baseline factor, a complexity factor, or a time calibration; and
communicating, by the processor, the AI work score, to at least one of: the AI user, the supervisor or stakeholders.

2. The method of claim 1, wherein the online data associated with the AI user comprises at least one of: an Al-assigned task, an AI user disclosure, AI user data, or a final work product.

3. The method of claim 1, wherein the online data associated with the supervisor comprises at least one of: supervisor input, the Al-assigned task, supervisor data, or a final work product.

4. The method of claim 1, further comprising facilitating, by the processor, the exchange of online data between the AI user and the supervisor.

5. The method of claim 1, further comprising enabling the supervisor, via an interface provided by the processor, to customize the AI work score by selecting and adjusting the weights assigned to at least one of: an AI integration factor, a work baseline factor, a complexity factor or a time calibration.

6. The method of claim 1, wherein the online data is further processed to generate at least one of: a composite AI work score, composite scores by tasks, composite scores by users, sub-scores by users, sub-scores by tasks, or classifications by at least one of:
groupings, rankings, subject matter, time, industries, KPI standards, or other sub-scoring categorizations.

7. The method of claim 1, further comprising analyzing the AI work score, the composite scores, the sub-scores and classifications to produce one or more correlation reports.

8. The method of claim 1, wherein communicating the AI work score, the composite scores, the sub-scores, classifications or correlation reports, comprises dynamically generated data visualizations, including at least one of: graphs, charts, illustrations, or customizable dashboards tailored to user preferences and task requirements.

9. The method of claim 1, wherein communicating further comprises generating notifications, alerts, or messages when at least one of: the AI work score, the composite scores, or the sub-scores exceed or fall below certain predefined thresholds.

10. A system for calculating an AI work score, the system comprising:
a processor configured to:
collect online data, associated with an AI user;
collect online data, associated with a supervisor;
determine, using scoring algorithms, an AI work score, wherein the online data is assigned numerical values corresponding to at least one of: an AI integration factor, a work baseline factor, a complexity factor, or a time calibration; and
communicate, the AI work score to at least one of: the AI user, the supervisor or stakeholders.

11. The system of claim 10, wherein the online data associated with the AI user comprises at least one of: an AI-assigned task, an AI user disclosure, AI user data, or a final work product.

12. The system of claim 10, wherein the online data associated with the supervisor comprises at least one of: supervisor input, an Al-assigned task, supervisor data, or a final work product.

13. The system of claim 10, wherein the processor is further configured to facilitate the exchange of online data between the AI user and the supervisor.

14. The system of claim 10, wherein the processor is configured to provide an interface enabling the supervisor to customize the AI work score by selecting and adjusting the weights assigned to at least one of: an AI integration factor, a work baseline factor, a complexity factor or a time calibration.

15. The system of claim 10, wherein the processor is further configured to generate at least one of: a composite AI work score, composite scores by tasks, composite scores by users, sub-scores by users, sub-scores by tasks, or classifications by at least one of:
groupings, rankings, subject matter, time, industries, KPI standards, or other sub-scoring categorizations based on the online data.

16. The system of claim 10, wherein the processor is further configured to analyze the AI work score, the composite scores, the sub-scores and classifications to generate one or more correlation reports.

17. The system of claim 10, wherein the processor is further configured to generate dynamic data visualizations, such as at least one of: graphs, charts, illustrations, or customizable dashboards tailored to user preferences and task requirements, for the AI work score, composite scores, sub-scores, classifications or correlation reports.

18. The system of claim 10, wherein the processor is further configured to generate notifications, alerts, or messages when at least one of: the AI work score, the composite scores, or the sub-scores exceed or fall below predefined thresholds.

19. A non-transitory computer-readable medium comprising instructions that, when executed by one or more processors, perform operations comprising:
collecting, online data, associated with an AI user;
collecting, online data, associated with a supervisor;
determining, using scoring algorithms, an AI work score, wherein the online data is assigned numerical values corresponding to at least one of: an AI integration factor, a work baseline factor, a complexity factor, or a time calibration; and
communicating the AI work score to at least one of: the AI user, the supervisor or stakeholders.
